(19) United States
(12) Patent Application Publication
(10) Pub. No.: US 2003/0019337 A1
(43) Pub. Date: Jan. 30, 2003

(54) Cutting device and method of use

(75) Inventor: Keith Hatanaka, La Jolla, CA (US)

Correspondence Address: LYON & LYON LLP, 633 WEST FIFTH STREET, SUITE 4700, LOS ANGELES, CA, 90071, US

(73) Assignee: S Twenty One International, Inc

(21) Appl. No.: 09/915,164

(22) Filed: Jul. 25, 2001

(51) Int. Cl. B26D 1/00; B67B 7/00

(52) U.S. Cl. 83/13; 30/2; 30/294

(57) ABSTRACT

A method and cutting device for unwrapping a case, such as a CD or DVD case wrapped in thin packaging material such as cellophane and adhesive tape, the case comprising two adjacent parallel plates defining a profile with a narrow side. The cutting device may comprise a longitudinally extending gripping arm adapted to be gripped at least partially in the palm of a user's hand, a cutting blade adapted to cut packaging material, and a cutting guide attached to the gripping arm, the cutting guide adapted to guide the sharpened tip of the cutting blade along the narrow side of the case. The cutting device has a longitudinal axis which may be held substantially perpendicular to the longitudinal axis of the case during cutting.

### FIELD OF THE INVENTION

The present invention relates to cutting devices, and in particular to cutting devices for unwrapping a packaged case.

### BACKGROUND OF THE INVENTION

Referring to FIG. 1, there is shown a perspective view of a conventional packaged compact disk (CD) case 10. The CD case 10 comprises a hollow rectangular case body 10 having a front plate 20 and a rear plate 30 that are hingeably attached by tabs 40. The tabs 40 are integral to serrated top and bottom sides 50, 60, which may be integral to front plate 20. When the CD case 10 is closed, the front plate 20 is parallel to and in close proximity with the rear plate 30. The top and bottom sides 50, 60 are thus narrow, extending the short distance from the front plate 20 to the rear plate 30.

During packaging of the CD case 10, a first strip of adhesive tape 70 is applied over the top side 50 such that the adhesive strip 70 extends down the front and rear plates 20, 30. The adhesive strip 70 holds the CD case shut, preventing theft of CD's from inside the CD case and providing an additional area for labeling. A second reinforced adhesive strip 80 may also be provided as an additional theft deterrent. The adhesive strips 70, 80 strongly adhere to front and rear plates 20, 30 but tend not to adhere to serrated top side 50. After the adhesive strips 70, 80 are applied, the CD case 10 is enveloped in transparent wrapping material, such as cellophane, in preparation for sale.

Upon purchasing a new compact disk, a consumer must remove the cellophane and adhesive strips 70, 80 before opening the CD case 10. However, this seemingly simple task can be surprisingly difficult and time-consuming. The cellophane is designed to fit very tightly around the perimeter of the CD case 10, making it nearly impossible to peel off with one's fingernails. Alternatively, if an implement such as scissors or a knife is employed, the CD case may be scratched, or worse, the scissors or knife may slip off the narrow top side 50 of the CD case 10 and injure the consumer.

After removal of the cellophane, the consumer typically peels off the adhesive strips 70, 80. However, adhesive strips 70, 80 are difficult to peel off because they strongly adhere to the smooth plastic surfaces of front and rear plates 20, 30. The first adhesive strip 70 is particularly difficult to peel because it tends to shear into multiple pieces during peeling. A need therefore exists for a tool to facilitate safe and easy removal of packaging such as cellophane and adhesive tape from unwrapped cases, such as newly purchased CD and DVD cases.

### SUMMARY OF THE INVENTION

An aspect of the invention involves a cutting device for unwrapping a packaged case such as a CD case having two plates connected by a common hinge and held together by a strip of adhesive tape or packaging material such as cellophane. In one embodiment, the cutting device includes a longitudinally extending gripping arm dimensioned to facilitate holding the cutting device in the palm of a hand using a thumb and at least one finger, and a cutting blade extending from the gripping arm and adapted for cutting adhesive tape and cellophane. The cutting device further includes a cutting guide adapted to guide the cutting blade in an approximately straight line along a narrow side of the case, the guide preventing the cutting device from slipping off the narrow side.

Another aspect of the invention involves a cutting device for unwrapping a packaged case such as a CD case, wherein the gripping arm includes a gripping region with a central indentation dimensioned for receiving the thumb of a user.

A further aspect of the invention involves a cutting device for unwrapping a packaged case such as a CD case, including a cutting blade having an arcuate cutting edge adapted to be run along an edge of the case to cut the cellophane and adhesive strips.

Yet another aspect of the invention involves a cutting device for unwrapping a packaged case such as a CD case where the cutting device comprises a longitudinally extending body that is dimensionally adapted to be gripped in the palm of a user's hand, the cutting device comprising a projection adapted to guide the cutting device along the upper edge of the CD case as the cutting device is displaced in a direction perpendicular to the longitudinal axis of the cutting device. In one embodiment the cutting device includes a retractable cutting blade and a thumb tab displaceable within a slot such that the cutting blade moves from a retracted safety configuration to an extended cutting configuration. The cutting device may resemble or be an ink pen that extends a cutting blade when a button on the pen is pushed.

An additional aspect of the invention involves a method of unwrapping a packaged case such as a CD case having two plates connected by a common hinge and held together by a strip of adhesive tape on the narrow top edge of the case, the case being wrapped in cellophane or other wrapping material. The method includes the steps of providing a cutting device having a longitudinally extending gripping arm, a cutting blade extending from the gripping arm and a cutting guide, gripping the case with a first hand and gripping the cutting device in the palm of a second hand, holding the cutting blade against the narrow top edge of the case with the cutting guide adjacent a side edge of the case, and running the cutting blade along the narrow top edge of the case while maintaining the cutting guide adjacent the side edge of the case. In one embodiment the cutting device is positioned such that the longitudinal axis of the gripping arm is not parallel to the longitudinal axis of the top edge of one of the plates of the case.

Other features and advantages of the invention will be evident from reading the following detailed description, which is intended to illustrate, but not limit, the invention.

### BRIEF DESCRIPTION OF THE DRAWINGS

The drawings illustrate the design and utility of preferred embodiments of the present invention, in which similar elements are referred to by common reference numerals.

FIG. 1 shows a front perspective view of a conventionally packaged CD case.

FIG. 2A shows a right side view of an example embodiment of the cutting device of the present invention.

FIG. 2B shows a left side view of the example embodiment of FIG. 2A.

FIG. 2C shows a bottom view of the example embodiment of FIG. 2A.

FIG. 2D shows a front view of the cutting device of FIG. 2A opening a packaged CD case.

FIG. 3A shows a side view of another example embodiment of the cutting device of the present invention.

FIG. 3B shows a front view of the cutting device of FIG. 3A opening a packaged CD case.

FIG. 4A shows a side view of yet another example embodiment of the cutting device of the present invention, with the cutting arm extended.

FIG. 4B shows a side view of the cutting device of FIG. 4A, with the cutting arm retracted.

FIG. 5A shows a side view of still another example embodiment of the cutting device of the present invention, with the cutting arm extended.

FIG. 5B shows a side view of the cutting device of FIG. 5A, with the cutting arm retracted.

FIG. 6A shows a top view of even another example embodiment of the cutting device of the present invention, with the cutting blade extended.

FIG. 6B shows a top view of the cutting device of FIG. 6A, with the cutting blade retracted.

FIG. 6C shows a side view of the cutting device of FIG. 6A, with the cutting blade extended.

FIG. 6D shows a side view of the cutting device of FIG. 6A, with the cutting blade retracted.

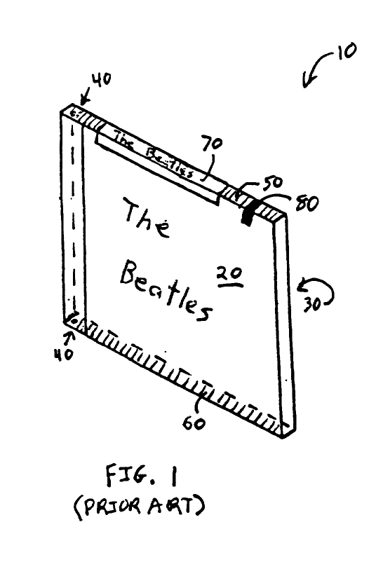

### DETAILED DESCRIPTION OF PREFERRED EMBODIMENTS

In some of the embodiments described below, a cutting device 100 is used to unwrap a packaged compact disk CD case 10. However, it is to be understood that the use of a CD case 10 is for illustrative purposes only and the cutting device may be employed as a cutting tool to unwrap other cases, such as digital video disk DVD cases, audio cassette cases, or any other hard, smooth container wrapped in tape, cellophane, paper or similar packaging. Further, though the packaging in certain embodiments may comprise cellophane, it is to be understood that any other suitable packaging material could be substituted for cellophane.

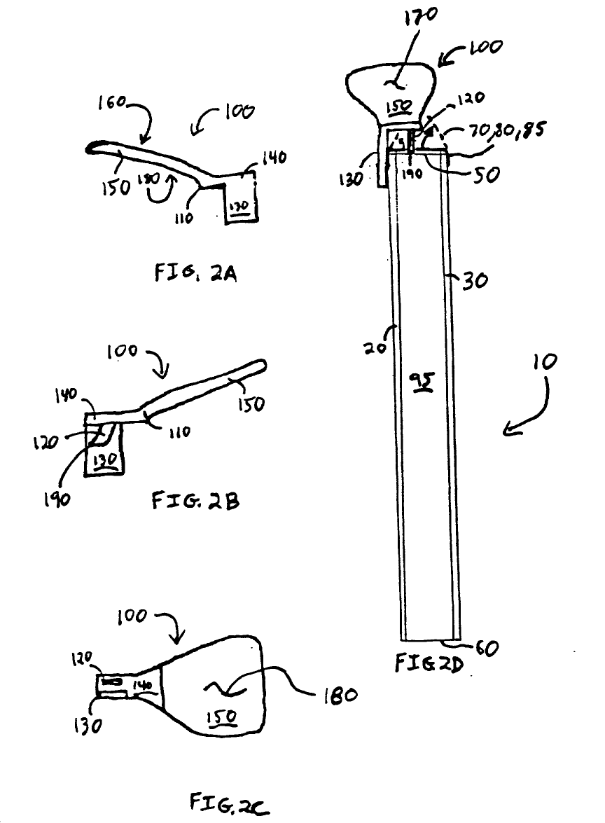

FIGS. 2A-2D illustrate an example embodiment of a cutting device 100 for unwrapping a packaged case 10 such as a CD case. The cutting device 100 comprises a longitudinally extending gripping arm 110, a cutting blade 120 and a cutting guide 130. The gripping arm 110 includes a base region 140 and an angled gripping region 150 for holding the device. The gripping region 150 has an upper surface 160 with an optional central indentation 170 and a flat lower surface 180. During use of the cutting device 100, the gripping arm 110 is adapted to be held into the palm of the user's hand using a thumb positioned on upper surface 160 and at least one finger positioned on lower surface 180.

As best seen in FIGS. 2B and 2D, the cutting blade 120 and cutting guide 130 extend downwardly from the base region 140 in a substantially perpendicular direction. The cutting blade 120 includes a sharpened distal tip 190 for cutting the adhesive strips 70, 80 and cellophane or other wrapping material on newly purchased case 10. The cutting guide 130 is longer than cutting blade 120 so that it may direct the cutting blade along an approximately straight line when cutting blade 120 is run along the narrow top side 50 of case 10. The cutting guide 130 is adapted to slide along one of the sides 20, 30 of case 10, preventing the cutting device 100 from sliding off the narrow top side 50, thus preventing injury to the user.

As explained above, a conventional CD case 10 is packaged with a first strip of adhesive strip 70 applied over the top side 50 of the case 10 and a layer of cellophane 85 encompassing the case. A reinforced adhesive strip 80 may also be applied over the top side 50 as an additional anti-theft measure. As best seen in FIG. 2D, the cutting blade is designed to cut through both adhesive strips 70, 80 and cellophane 85 in one simple motion.

A method of using the cutting device 100 depicted in FIGS. 2A-2D will now be described. A user of cutting device 100 grips the case 10 with a first hand and grips the cutting device 100 with a second hand. The thumb of the second hand engages top surface 160. Optionally, the thumb of the second hand fits snugly within indentation 170 to aid in gripping the device 100. One or more fingers of the second hand are placed on the lower surface 180 of the gripping region 150, securing a portion of the cutting device 100 in the palm of the second hand to increase the user's control over the cutting device. The cutting guide 130 is placed adjacent the case 10 such that cutting guide 130 abuts the front plate 20 adjacent top side 50. The user then manipulates the cutting device 100 so the sharpened distal tip 190 of cutting blade 120 is positioned against the top side 50 adjacent a front edge 95 of case 10. While maintaining the cutting guide 130 against the front plate 20, the user runs the sharpened distal tip 190 along the top side 50 of the case 10, cutting the adhesive strips 70, 80 and the cellophane 85.

The adhesive strips 70, 80 and cellophane 85 do not adhere well to the serrated top side 50 and fray upwardly when cut, conveniently providing a means to peel the adhesive strips 70, 80 and cellophane 85 from the case 10. After the adhesive strips 70, 80 and cellophane 85 are removed, the case 10 may be opened.

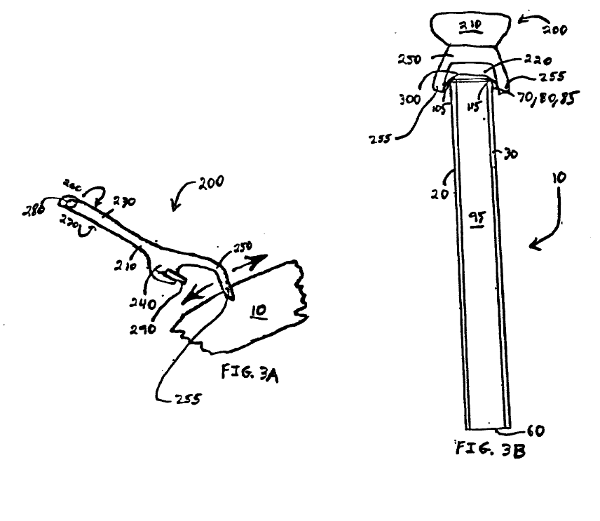

FIGS. 3A and 3B illustrate another example embodiment of a cutting device 200 for unwrapping a packaged case 10 such as a CD case. This embodiment adds a cutting element to a conventional, key-ring-mountable bottle opener. The cutting device 200 comprises a longitudinally extending gripping arm 210 and a cutting blade 220. The longitudinally extending gripping arm 210 includes a gripping region 230, a base region 240 and a cutting blade support region 250 for holding the cutting blade 220. The gripping region 230 has an upper surface 260 and a lower surface 270. The cutting blade support region 250 has cutting guides 255.

During use of the cutting device 200, the gripping arm 210 is adapted to be held using a thumb positioned on upper surface 260 and at least one finger positioned on lower surface 270, the at least one finger holding the longitudinally extending gripping arm 210 against the palm of the hand. As best seen in FIG. 3A, the gripping region 230 includes an aperture 280 for a key ring and the base region 240 includes a projection 290 to be used as a bottle opener.

Referring to FIG. 3B, the cutting blade 220 is held in place by cutting blade support region 250. The cutting blade 220 includes a cutting edge 300 that is designed to be run along the upper side 50 of the case 10 to cut the adhesive strips 70, 80 and cellophane on unwrapped case 10. Cutting guides 255 extend at least partially down front plate 20 and rear plate 30 to prevent the cutting device 200 from slipping off the upper side 50. For best results, the arcuate cutting edge 300 is preferably concave or trapezoidal to enable shearing of the adhesive strips 70, 80 and cellophane 85 at the corner 105 and comer 115. However, it is understood that a sharp member of any appropriate geometry may be used for cutting blade 220, including a plurality of sharp members positioned adjacent cutting guides 255.

A method of using the cutting device 200 depicted in FIGS. 3A and 3B will now be described. A user of cutting device 200 grips the case 10 with a first hand and grips the cutting device 200 with a second hand so that the thumb is placed on upper surface 260 and one or more fingers of the second hand are placed on the lower surface 270. The user then manipulates the cutting device 200 so the cutting edge 300 of cutting blade 220 is positioned against the comers 105, 115 adjacent the front edge 95 of case 10, and so the cutting guides 255 extend at least partially down front plate 20 and rear plate 30. While maintaining the cutting blade 220 against the corners 105, 115, the user runs the cutting blade 220, guided by cutting guides 255, along the top side 50 of the case 10, cutting the adhesive strips 70, 80 and the cellophane 85 neatly at the corners 105, 115.

Since the adhesive strips 70, 80 do not adhere well to the serrated top side 50, the cutout portion of the adhesive strips 70, 80 and the cellophane 85 can easily be removed and disposed of. After the adhesive strips 70, 80 and cellophane 85 are removed, the case 10 may be opened.

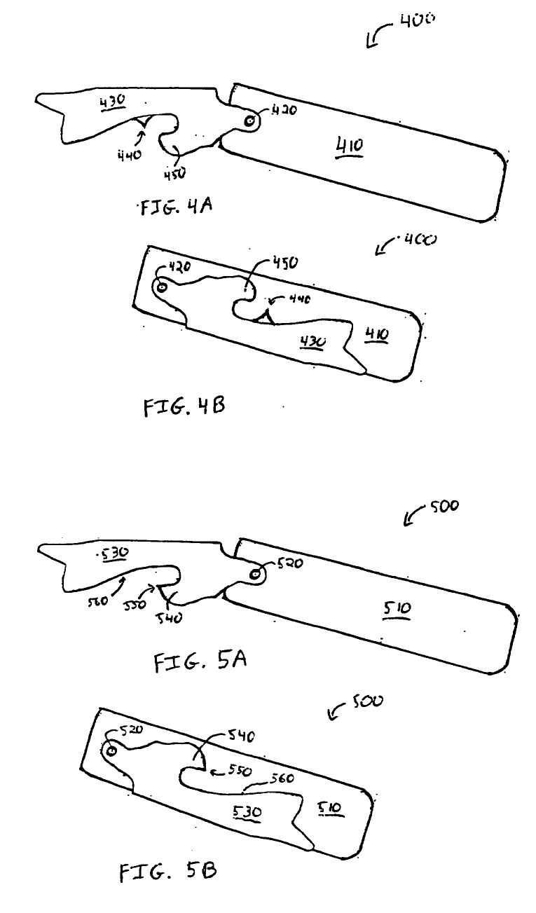

FIGS. 4A and 4B illustrate a further example embodiment of a cutting device 400 for unwrapping a packaged case 10 such as a CD case 10. The cutting device 400 includes a longitudinally extending gripping arm 410, a hinge 420 and a rotatable cutting arm 430 having a longitudinal axis. The cutting arm further includes a cutting blade 440 and a projection 450 adapted to be used as both a cutting guide and a conventional bottle opener. The cutting arm 430 is adapted to be rotated at hinge 420 relative to the gripping arm 410 from the retracted safety configuration depicted in FIG. 4B to the extended cutting configuration depicted in FIG. 4A, and vice-versa.

While in the extended cutting configuration, a user holds the gripping arm 410 with one hand and an unwrapped case 10 with the other hand. The projection 450 is used to guide the cutting blade 440 along the narrow upper side 50 of the case 10 as the cutting device is displaced in a direction perpendicular to the longitudinal axis of cutting arm 430. As the projection 450 runs along either side 20, 30 of case 10, the cutting blade 440 cuts the adhesive strips 70, 80 and cellophane on the case 10.

FIGS. 5A and 5B illustrate an additional example embodiment of a cutting device 500 for unwrapping a packaged case 10 such as a CD case. Similar to the previous embodiment, this embodiment features a cutting device 500 including a longitudinally extending gripping arm 510, a hinge 520 and a rotatable cutting arm 530 having a longitudinal axis and a projection 540 adapted to be used as a conventional bottle opener. However, the projection 540 of this embodiment has a sharpened tip 550 to cut through the wrapping material, for instance, the adhesive strips 70, 80 and cellophane on a CD case 10. The cutting arm 530 features an arcuate surface 560 for guiding the sharpened tip 550 along either side 20, 30 of case 10.

While in the extended cutting configuration as depicted in FIG. 5A, a user holds the longitudinally extending gripping arm 510 in the palm of one hand and an unwrapped case 10 in the other hand. The arcuate surface 560 is used to guide the sharpened tip 550 along either side 20, 30 of case 10 as the cutting device is displaced in a direction perpendicular to the longitudinal axis of cutting arm 530. As the arcuate surface 560 runs along the top side 50 of CD case 10, the sharpened tip 550 cuts the packaging material, for instance the adhesive strips 70, 80 and cellophane on a newly purchased CD case 10.

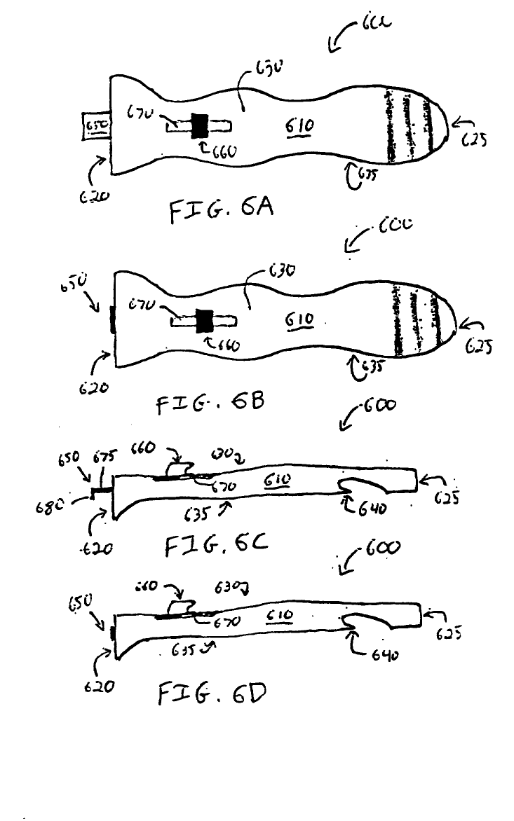

FIGS. 6A-6D illustrate another example embodiment of a cutting device 600 for unwrapping a packaged case 10 such as a CD case 10. The cutting device 600 includes a longitudinally extending gripping arm 610 having a flat front end 620, a rear end 625, a top surface 630, a bottom surface 635 and a longitudinal axis. The bottom surface 635 includes a projection 640 adapted to be used as a conventional bottle opener. The cutting device 600 further includes a retractable cutting blade 650 and a thumb tab 660 located on top surface 630. The thumb tab 660 is displaceable within slot 670 such that it may move parallel to the longitudinal axis of the gripping arm 610. By moving the thumb tab 660 toward the front end 620, the cutting blade 650 moves from the retracted safety configuration depicted in FIGS. 6B and 6D to the extended cutting configuration depicted in FIGS. 6A and 6C.

As best seen in FIG. 6C, the retractable cutting blade 650 includes a longitudinally extending base section 675 and a laterally extending cutting tip 680. While in the extended cutting configuration, a user holds the gripping arm 610 in the palm of one hand and a wrapped case 10 in the other hand. The flat front end 620 guides the cutting tip 680 along the upper side 50 of the case 10 as the cutting device is displaced in a direction perpendicular to the longitudinal axis of gripping arm 610. The user maximizes control over the cutting operation by holding the gripping arm 610 in the palm of one hand, with the longitudinal axis of gripping arm 610 approximately perpendicular to the sides 20, 30 of case 10. The longitudinal axis of gripping arm 610 is preferably held non-parallel to the sides 20, 30 for improved user ergonomics. As the flat front end 620 runs along either side 20, 30 of case 10, the cutting tip 680 cuts the wrapping material, such as adhesive strips 70, 80 and cellophane on an unopened CD case 10.

While alternative forms of the invention have been shown herein and described by way of illustration, other modifications and variations therein will probably occur to persons skilled in the art. For instance, any one or more of the features depicted in the figures, or described in the accompanying text, may be interchanged with that of another figure to form still other embodiments that would fall within the concluding claims. The concluding claims are thus intended to cover all such changes and modifications as fall within the true spirit and scope of the present invention.

What is claimed is:

1. A cutting device for unwrapping a case wrapped in thin packaging material, the case comprising two adjacent parallel plates defining a profile with a narrow side, the cutting device comprising:
a longitudinally extending gripping arm adapted to be gripped at least partially in the palm of a user's hand;
a cutting blade attached to the gripping arm, the cutting blade including a sharpened tip adapted to cut packaging material; and
a cutting guide attached to the gripping arm, the cutting guide adapted to guide the sharpened tip of the cutting blade along the narrow side of the case.

2. The cutting device of claim 1, wherein a strip of adhesive material is connected to the two plates, and the sharpened tip is adapted to cut the adhesive strip.

3. The cutting device of claim 1, wherein the cutting blade includes an arcuate cutting edge.

4. The cutting device of claim 3, wherein the arcuate cutting edge is adapted to be run along an edge of the case.

5. The cutting device of claim 1, wherein the longitudinally extending gripping arm includes a base region and a gripping region dimensioned to facilitate holding the cutting device with a thumb and at least one finger.

6. The cutting device of claim 5, wherein the cutting blade extends approximately perpendicularly from the base region.

7. The cutting device of claim 5, wherein the cutting guide extends approximately perpendicularly from the base region.

8. The cutting device of claim 5, wherein the cutting guide extends from the base region approximately parallel to the cutting blade.

9. The cutting device of claim 5, wherein the gripping region is angled with respect to the base region.

10. The cutting device of claim 5, wherein the gripping region includes a central indentation for receiving the thumb of a user.

11. The cutting device of claim 5, further including a projection to be used as a bottle opener extending from the base region.

12. The cutting device of claim 5, wherein the gripping region includes an aperture for a key ring.

13. A cutting device for unwrapping a packaged plastic case, the plastic case having two plates with narrow sides, the plates connected by a common hinge and further connected by a strip of adhesive tape across the narrow sides, the plastic case being wrapped in thin, transparent packaging material, the cutting device comprising:
a longitudinally extending gripping arm dimensioned to facilitate holding the cutting device in the palm of a hand with a thumb and at least one finger;
a cutting blade extending from the gripping arm and adapted for cutting the adhesive tape and thin, transparent packaging material; and
a cutting guide extending from the gripping arm and adapted for guiding the cutting device along the case, wherein the cutting guide is positioned relative to the cutting blade so as to guide the cutting blade along the narrow sides of the two plates and along the strip of adhesive tape.

14. The cutting device of claim 13, wherein the cutting blade includes an arcuate cutting edge.

15. The cutting device of claim 14, wherein the arcuate cutting edge is adapted to be run along an edge of the case.

16. The cutting device of claim 13, wherein the longitudinally extending gripping arm includes a base region and a gripping region.

17. The cutting device of claim 16, wherein the cutting blade extends approximately perpendicularly from the base region.

18. The cutting device of claim 16, wherein the cutting guide extends from the base region approximately parallel to the cutting blade.

19. The cutting device of claim 16, wherein the cutting guide extends approximately perpendicularly from the base region.

20. The cutting device of claim 16, wherein the gripping region is angled with respect to the base region.

21. The cutting device of claim 16, wherein the gripping region includes a central indentation for receiving the thumb of a user.

22. The cutting device of claim 16, further including a projection to be used as a bottle opener extending from the base region.

23. The cutting device of claim 16, wherein the gripping region includes an aperture for a key ring.

24. A cutting device for unwrapping a case wrapped in thin packaging material, the case comprising two adjacent parallel plates defining a profile with a narrow side, the cutting device comprising:
a longitudinally extending gripping arm adapted to be gripped at least partially in the palm of a user's hand;
a cutting arm hingeably mounted to the gripping arm;
a cutting blade attached to the cutting arm, the cutting blade including a sharpened tip adapted to cut packaging material; and
a cutting guide attached to the cutting arm, the cutting guide adapted to guide the sharpened tip of the cutting blade along the narrow side of the case.

25. The cutting device of claim 24, wherein the cutting arm is adapted to be rotated relative to the gripping arm from a retracted safety configuration to an extended cutting configuration.

26. The cutting device of claim 24, wherein the cutting arm has a longitudinal axis, and, in use, the cutting arm is adapted to be moved perpendicular to its longitudinal axis when cutting.

27. The cutting device of claim 24, wherein the cutting guide is a projection that is adapted for use as a bottle opener.

28. The cutting device of claim 24, wherein the cutting blade is a projection extending from the cutting arm.

29. The cutting device of claim 28, wherein the projection is adapted for use as a bottle opener.

30. A cutting device for unwrapping a case wrapped in thin packaging material, the case comprising two adjacent parallel plates defining a profile with a narrow side, the cutting device comprising:
a longitudinally extending gripping arm adapted to be gripped at least partially in the palm of a user's hand;
a cutting blade slidably attached to the gripping arm, the cutting blade including a sharpened tip adapted to cut packaging material, and the cutting blade adapted to be displaced longitudinally relative to the gripping arm from a retracted safety configuration to an extended cutting configuration; and
a cutting guide attached to the gripping arm, the cutting guide adapted to guide the sharpened tip of the cutting blade along the narrow side of the case when the cutting blade is in the extended cutting configuration.

31. The cutting device of claim 30, wherein the cutting blade includes a longitudinally extending base section and a laterally extending cutting tip.

32. The cutting device of claim 30, wherein the gripping arm includes a front end with a flat surface, the flat surface comprising the cutting guide.

33. The cutting device of claim 30, further including a longitudinally displaceable thumb tab for displacing the cutting blade longitudinally relative to the gripping arm.

34. The cutting device of claim 30, wherein the cutting device is shaped to resemble an ink pen.

35. The cutting device of claim 30, wherein the gripping arm has an upper surface and a lower surface.

36. The cutting device of claim 35, wherein the upper surface includes a longitudinally extending slot surrounding a portion of the thumb tab, the longitudinally extending slot adapted to permit the thumb tab to be displaced longitudinally.

37. The cutting device of claim 35, wherein the lower surface includes a projection adapted to be used as a bottle opener.

38. A method of unwrapping a case wrapped in thin packaging material, the case comprising two adjacent parallel plates defining a profile with a narrow side, the method comprising the steps of:
providing a cutting device having:
a longitudinally extending gripping arm adapted to be gripped at least partially in the palm of a user's hand;
a cutting blade attached to the gripping arm, the cutting blade including a sharpened tip adapted to cut packaging material; and
a cutting guide attached to the gripping arm, the cutting guide adapted to guide the sharpened tip of the cutting blade along the narrow side of the case;
gripping the case with a first hand and gripping the cutting device at least partially in the palm of a second hand;
holding the cutting blade against the narrow side of the case while holding the cutting guide against the case; and
running the cutting blade along the narrow side of the case while running the cutting guide along a plate.

39. The method of claim 38, wherein the step of running the cutting blade along the narrow side of the case includes the step of cutting the thin packaging material.

40. The method of claim 38, wherein adhesive tape is attached to the narrow side of the case, and wherein the step of running the cutting blade along the narrow side of the case includes the step of cutting the adhesive tape.

41. The method of claim 40, further including the step of removing the thin packaging material from the case.

42. The method of claim 41, further including the step of removing the adhesive tape from the case.

43. The method of claim 42, further including the step of opening the case.

44. A method of unwrapping a case wrapped in thin packaging material, the case comprising two adjacent parallel plates defining a profile with a narrow side, the case having a first longitudinal axis, the method comprising the steps of:
providing a cutting device having:
a longitudinally extending gripping arm having a second longitudinal axis and adapted to be gripped at least partially in the palm of a user's hand;
a cutting blade attached to the gripping arm, the cutting blade including a sharpened tip adapted to cut packaging material; and
a cutting guide attached to the gripping aim, the cutting guide adapted to guide the sharpened tip of the cutting blade along the narrow side of the case;
gripping the case with a first hand and gripping the cutting device at least partially in the palm of a second hand;
holding the cutting blade against the narrow side of the case while holding the cutting guide against the case such that the first longitudinal axis of the gripping arm is not substantially parallel to the second longitudinal axis of the case; and
running the cutting blade along the narrow side of the case while running the cutting guide along the case and while maintaining the first longitudinal axis of the gripping arm approximately perpendicular to the second longitudinal axis of the case.
